(19) United States
(12) Patent Application Publication
(10) Pub. No.: US 2004/0190050 A1
(43) Pub. Date: Sep. 30, 2004

(54) Method of reporting status of execution of print job

(76) Inventor: Norihiko Sunohara, Yokohama (JP)

Correspondence Address: SWIDLER BERLIN SHEREFF FRIEDMAN, LLP, 3000 K STREET, NW, BOX IP, WASHINGTON, DC, 20007, US

(21) Appl. No.: 10/778,246

(22) Filed: Feb. 17, 2004

(30) Foreign Application Priority Data
Mar. 26, 2003 (JP) 2003-086479

(51) Int. Cl. G06F 15/00; G06F 3/00

(52) U.S. Cl. 358/1.15; 710/19; 358/1.16

(57) ABSTRACT

In a method of sending a report of completion of a print job to a terminal different from a print requesting terminal, a print server receives a print request from a terminal connected to a network, including print data and information of a terminal to which a print completion report is to be sent, and manages the received information. When the print server receives a print completion report from a printer, the print server identifies a terminal to which the print completion report is to be sent, and sends the report to this terminal.

### BACKGROUND OF THE INVENTION

1. Field of the Invention

The present invention generally relates to printing systems for print servers or printers that receive print instructions from a plurality of terminals connected to a network, and particularly to a printing system for managing the terminals to which print completion reports are to be transmitted.

2. Description of the Related Art

In general, a print server or printer connected to a network receives print instructions from a plurality of terminals, and prints data in turn. A monitoring function of the print server or the printer allows each terminal to recognize the state of print data (ready to print, in progress, or print completion). When each terminal recognizes that a print job is completed, the terminal user goes to the printer to pick up the printed document. A method to recognize completion of a print job in real time is described in Japanese Unexamined Patent Application Publication No. 7-156461 in which a print-completion indication sound corresponding to a terminal identification number is generated so that the terminal user can recognize that the print job requested by him/her has completed.

However, the above-described method requires a time-consuming operation when a first user who requests a print job and a second user who uses the printed document corresponding to the requested print job are different. Specifically, when the first user recognizes that the print job has completed from a print server or a printer by the method described above, he/she must pick up the printed document and deliver it to the second user. Alternatively, the first user must notify the second user that the printed document has been provided by the printer, so that the second user can pick up the printed document. This causes problems such as failures in teamwork.

There is another problem in that, in a case where a terminal and a printer are connected over a network and are at remote locations, such as when they are on different floors, the user will not hear the print-completion indication sound generated by the printer and cannot pick up the printed document in real time at print completion.

Still another problem occurs in that, in a case where sending print requests and using printed documents are performed by different users, users who send print requests must distribute the printed documents to appropriate users.

### SUMMARY OF THE INVENTION

Accordingly, it is an object of the present invention to provide a print status reporting method in which, in a case where the user who requests a print job and the user who uses the printed document corresponding to the requested print job are different, the user who uses the printed document can recognize completion of the print job in real time and the user who requests the print job need not perform the time-consuming operation of notifying the other user of print completion.

According to the present invention, a terminal transmits a print request with information for specifying a terminal to which a report of completion of the print job is to be transmitted. When the print job is completed, a print server or a printer sends a print completion report to the specified terminal rather than to the requesting terminal. The destination to which the print completion report is to be transmitted may be determined based on terminal identification information such as an IP address. The destination may also be determined based on a distribution table including information of assigned terminals responsible corresponding to businesses if each terminal can be assigned to each business, in which case the business that uses a certain printed document can be determined.

Therefore, at print request time, a requesting user specifies the destination to which a report of completion of the print job is to be sent, so that a print server or a printer can send the report to the specified destination when the print job is completed. Moreover, a requesting user specifies at print request time the predetermined business type of the destination to which a report of completion of the print job is to be sent, so that the terminal of the specified business type can be notified of print completion even when the requesting user cannot specify a terminal to which the report is to be sent.

According to the present invention, therefore, a print server or a printer which receives a print request and print data including information of the destination to which a report of completion of the print job is to be sent is able to send the report to the specified destination rather than to the print requesting terminal when the print job is completed.

The print server or printer can maintain a distribution table for specifying terminals assigned to businesses. Once a user who requests a print job specifies a business of the destination to which a report of completion of the print job is to be sent, the report can be transmitted to the terminal corresponding to the specified business based on the distribution table. The user need not recognize a terminal to which the report is to be sent.

### BRIEF DESCRIPTION OF THE DRAWINGS

FIG. 1 is an overview diagram of a system according to an embodiment of the present invention;

FIG. 2 is a view of a print request database;

FIG. 3 is a view of another print request database;

FIG. 4 is a distribution table for specifying terminals assigned to businesses;

FIG. 5 is an output instruction screen to be used in a case where an output terminal ID is specified;

FIG. 6 is an output instruction screen to be used in a case where an output business ID is specified;

FIG. 7 is a view of a print completion report screen;

FIG. 8 is a flowchart showing a print data receiving process;

FIG. 9 is a flowchart showing a print data transmitting process;

FIG. 10 is a flowchart showing a print status receiving process; and

FIG. 11 is a flowchart showing a print record managing process.

### DESCRIPTION OF THE PREFERRED EMBODIMENTS

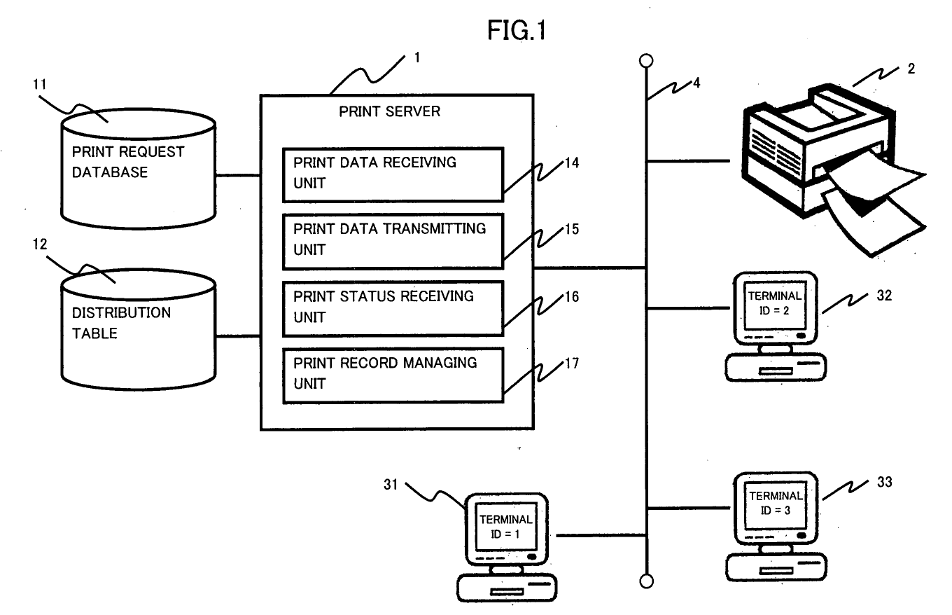

FIG. 1 is an overview of a system according to an embodiment of the present invention. A print server 1 and a printer 2 are connected to a plurality of terminals 31 to 33 over a network 4.

The print server 1 is an information processor such as a personal computer. The print server 1 is formed of a processing section that reads a program to perform an operation according to the program, and a storage device that stores the print data requested by the terminals 31 to 33 and information of terminals assigned to individual business.

The program is executed to write necessary information to a print request database 11 when print request information is sent to the print server 1 via the network 4 from the terminals 31 to 33, and to consecutively transmit print data to the printer 2 when the printer 2 is ready to receive print data. The print server 1 also receives error information or print completion information from the printer 2. The print server 1 sends an error report to a print requesting terminal when an error occurs, and sends a print completion report to a report destination terminal stored in the print request database 11 when printing is completed.

The printer 2 is a printing device. The printer 2 is formed of a processing section that reads a program to perform an operation according to the program, and a storage area (not shown).

The program is executed to print the print data transmitted from the print server 1 and to send to the print server 1 error information when a print error occurs or print completion information when printing is normally completed.

The terminals 31 to 33 are information processors, such as personal computers. When a user wants to print data prepared by an application in the terminals 31 to 33 or data obtained over a network such as the Internet, he/she selects a desired printer before sending a print request. At print request time, the user specifies the number of copies, the page(s) to print, etc., on a print setting screen, and also specifies a terminal to which a report is to be sent upon completion of the print job. Therefore, the print request and information of the destination terminal to which the print completion report is to be sent are transmitted to the print server 1. The print server 1 stores the transmitted print request and information in the print request database 11. When a print completion report is sent from the printer 2, the print server 1 extracts the destination terminal from the information stored in the print request database 11, and transmits the print completion report to this terminal.

A method of reporting print information according to an embodiment of the present invention will be described with reference to the drawings.

As shown in FIG. 1, the present system is constituted of the print server 1, the printer 2, and the terminals 31 to 33.

The print server 1 includes the print request database 11 that stores print data received from the terminals 31 to 33, a distribution table 12 that defines terminals assigned to the corresponding businesses, a print data receiving unit 14 that receives the print data from the terminals 31 to 33 and that stores the print data in the print request database 11, a print data transmitting unit 15 that consecutively transmits the print data to the printer 2, a print status receiving unit 16 that receives from the printer 2 print status information of a document to be printed and that transmits the print status information to a print requesting terminal or a print-completion-report destination terminal, and a print record managing unit 17 that deletes the print request data from the print request database 11 when the print status information from the printer 2 indicates print completion.

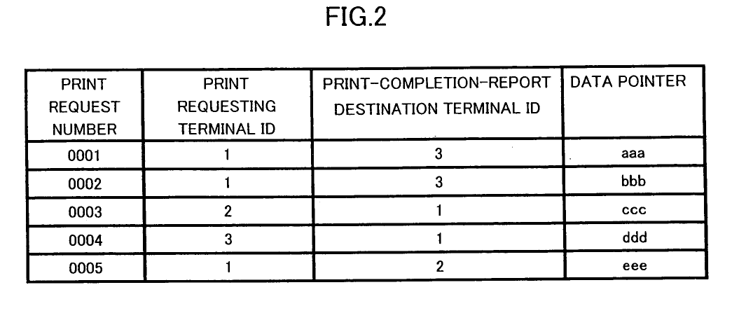

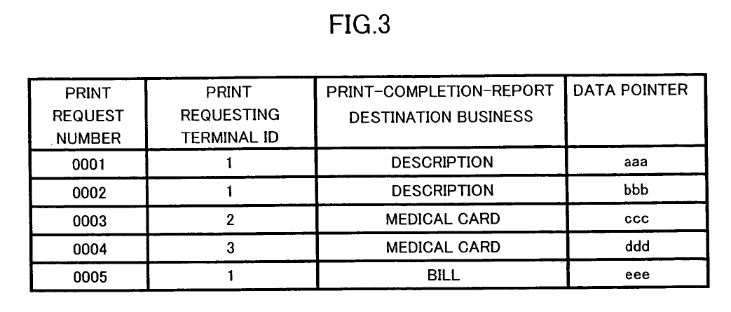

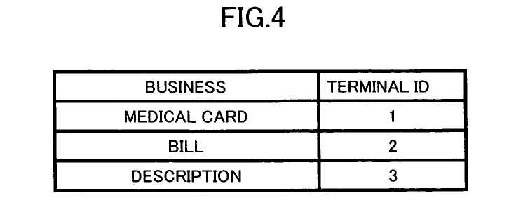

When the print data receiving unit 14 receives print data from any of the terminals 31 to 33, it stores the print data in a print data storage area (not shown), and also stores in the print request database 11 a print requesting terminal ID, a print-completion-report destination terminal ID, and a data pointer indicating the area where the print data is stored, as shown in FIG. 2. The print request database 11 may also store a print requesting terminal ID, a business of the print-completion-report destination, and a data pointer indicating the area where the print data is stored, as shown in FIG. 3. In the latter case, a terminal to which a print completion report is to be sent is determined based on the distribution table 12 shown in FIG. 4, as described in detail below.

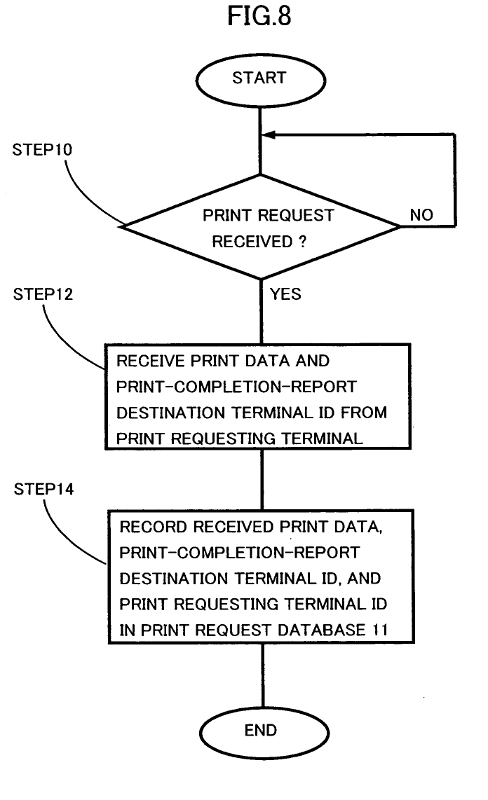

FIG. 8 is a flowchart showing a process of the print data receiving unit 14. The print data receiving unit 14 constantly monitors whether or not a print request has been sent from the terminals 31 to 33 (Step 10). When print data is received with information of a destination terminal to which a print completion report is to be sent (Step 12), the print data is stored in the storage area (not shown), and the data pointer indicating the storage area and information indicating the print requesting terminal and the print-completion-report destination terminal are recorded in the print request database 11 (Step 14). According to the process steps, the print data receiving unit 14 receives a print request from any of the terminals 31 to 33, and stores the print data in the storage area (not shown) and the print request database 11.

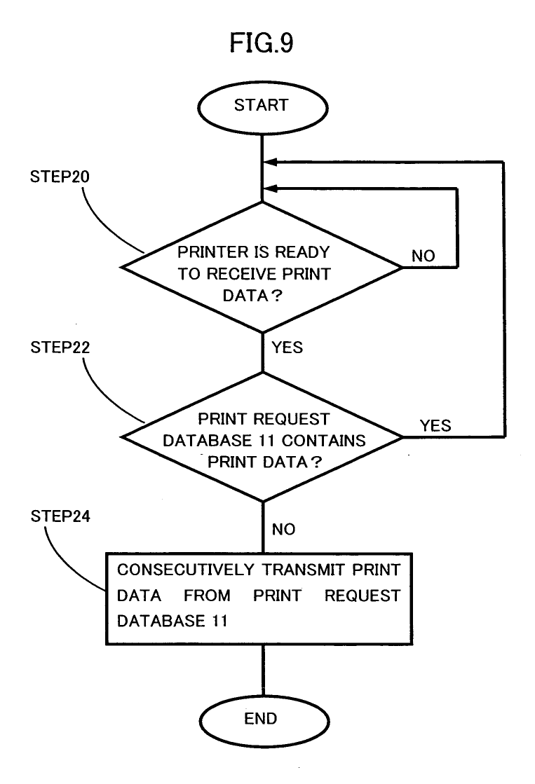

FIG. 9 is a flowchart showing a process of the print data transmitting unit 15. The print data transmitting unit 15 constantly monitors whether or not the printer 2 is ready to receive print data (Step 20). When the printer 2 is ready to receive print data, it is determined whether or not the print request database 11 contains print data (Step 22). If there is print data, the print data is consecutively transmitted from a data pointer stored in the print request database 11 (Step 24). According to the process steps, the print data transmitting unit 15 constantly monitors whether or not the printer 2 is ready to receive print data, and transmits the print data from a data pointer stored in the print request database 11 to the printer 2 when the printer 2 is ready to receive print data.

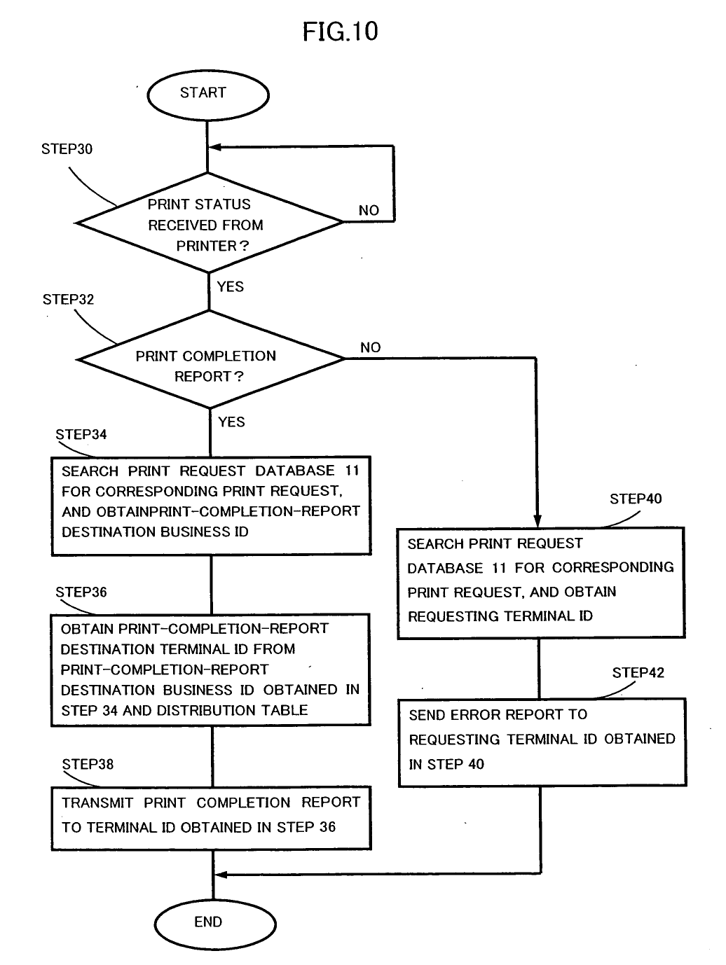

FIG. 10 is a flowchart showing a process of the print status receiving unit 16. The print status receiving unit 16 constantly monitors whether or not print status information has been sent from the printer 2 (Step 30). When print status is received from the printer 2, it determines whether or not the print status represents print completion (Step 32). The process proceeds to Step 34 if print completion has been reported, and proceeds to Step 40 otherwise.

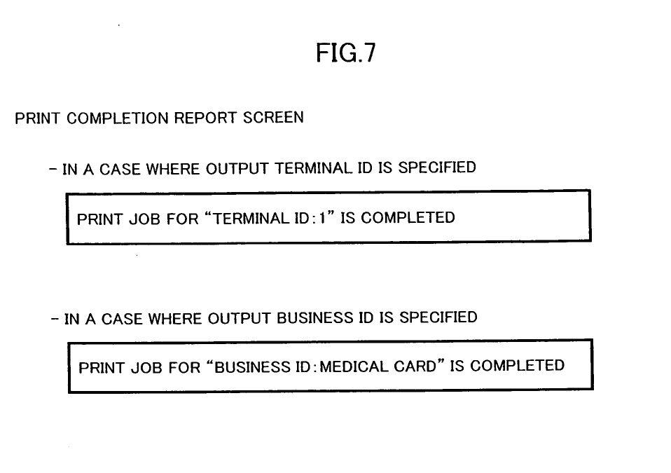

In Step 34, the print request database 11 is searched for the corresponding print request. Generally, the printer 2 sends a print status report together with identification information indicating the print request corresponding to the print status. This identification information identifies a print request number, by way of example, but is not limited thereto. Based on the print request number sent from the printer 2, a business of the destination to which a print completion report is to be sent is obtained. In Step 36, a terminal ID to which the print completion report is to be sent is obtained from the business obtained in Step 34 and the distribution table 2. In Step 38, the print completion report shown in FIG. 7 is sent to the terminal ID obtained in Step 36.

When processing for a print status other than print completion is to be performed, the process proceeds to Step 40, in which a print requesting terminal ID is obtained from the print request database 11 based on the print request number. In Step 42, the print status is reported to the print requesting terminal ID obtained in step 40. The print status reported in Step 42 includes errors such as an out-of-paper error and a paper jam error.

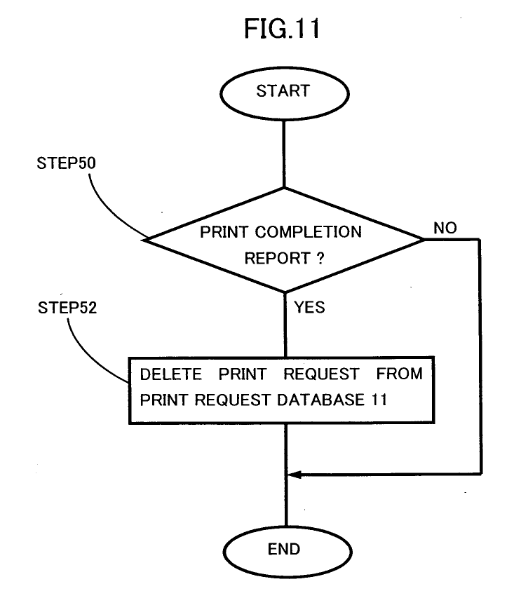

FIG. 11 is a flowchart showing a process of the print record managing unit 17. The print record managing unit 17 performs the process after the process of the print status receiving unit 16. It is determined whether or not the print status from the printer 2 indicates print completion (Step 50). If print completion has been reported, the print request database 11 is searched for the corresponding print request based on the print request number to delete the print request data (step 52).

In this way, the process when the print server 1 receives a print request from any of the terminals 31 to 33 until receiving a print completion report from the printer 2 is carried out.

A detailed description of the figures will now be made.

FIG. 2 is a view showing the structure of a print request database (Example 1). The print request database includes print request numbers, print requesting terminal IDs, print-completion-report destination terminal IDs, and data pointers. The print request numbers are automatically allocated to arriving print requests in turn. The print requesting terminal IDs include information for identifying terminals that sent the print requests. In FIG. 1, the terminal 31 is given ID=1, the terminal 32 is given ID=2, and the terminal 33 is given ID=3; the requesting terminal IDs represented by 1, 2, and 3 are stored. The requesting terminal IDs are not necessarily IDs of the individual terminals, and may be information for identifying terminals. The print-completion-report destination terminal IDs include information specified by any of the terminals 31 to 33 that sends a print request for identifying a terminal to which completion of the print job is to be reported. Like the print requesting terminal IDs, the print-completion-report destination terminal IDs are not necessarily IDs of the individual terminals, and may be information for identifying terminals. Each data pointer indicates the data start position of the print data stored in the storage area (not shown). As long as the data start position of the print data stored in each print request database is identified, for example, file names may be stored in the data pointers, and the pointers of file names may be stored in the storage area (not shown).

FIG. 3 is a view showing the structure of another print request database (Example 2). This print request database includes print request numbers, print requesting terminal IDs, print-completion-report destination businesses, and data pointers. The difference from the print request database shown in FIG. 2 is that the print-completion-report destination businesses are stored in place of the print-completion-report destination terminal IDs. The print-completion-report destination business include information specified by any of the terminals 31 to 33 that sends a print request for identifying a business of the destination to which completion of the print job is to be reported. In order to store a print-completion-report destination terminal ID shown in FIG. 2, each of the terminals 31 to 33 that sends a print request must recognize the destination to which completion of the print job is to be reported; whereas, by specifying a business of the destination which is to receive a print completion report, as shown in FIG. 3, each of the terminals 31 to 33 need not know information of the print-completion-report destination terminal in advance. In this case, the print server 1 obtains the ID of the terminal to which the report is to be sent based on the specified business from the distribution table 12 shown in FIG. 4, and sends the print completion report to this terminal ID.

FIG. 4 is a distribution table. The distribution table includes businesses and terminal IDs. The businesses include predetermined types of businesses, such as a medical card service, a billing service, and a prescription service, and the terminal IDs include information for identifying the terminals that handle the businesses. A single business is associated with at least one terminal ID.

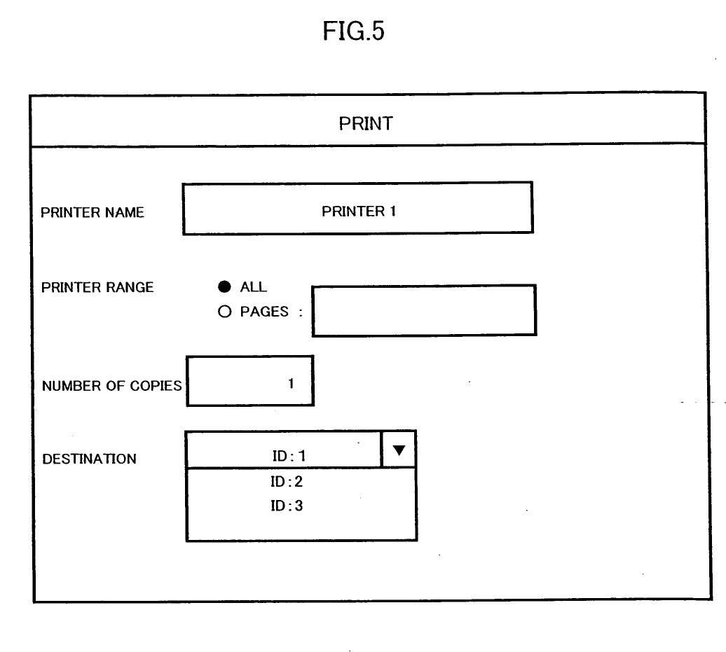

FIG. 5 is an output instruction screen on which an output instruction is performed at print request time from each of the terminals 31 to 33 (to specify an output terminal ID). The output instruction screen contains printer names indicating an output device to specify, a print range indicating a range of pages to print, the number of copies, and the destination to which the print report is to be sent. A terminal to which the print completion report is to be sent is specified in the “destination” field.

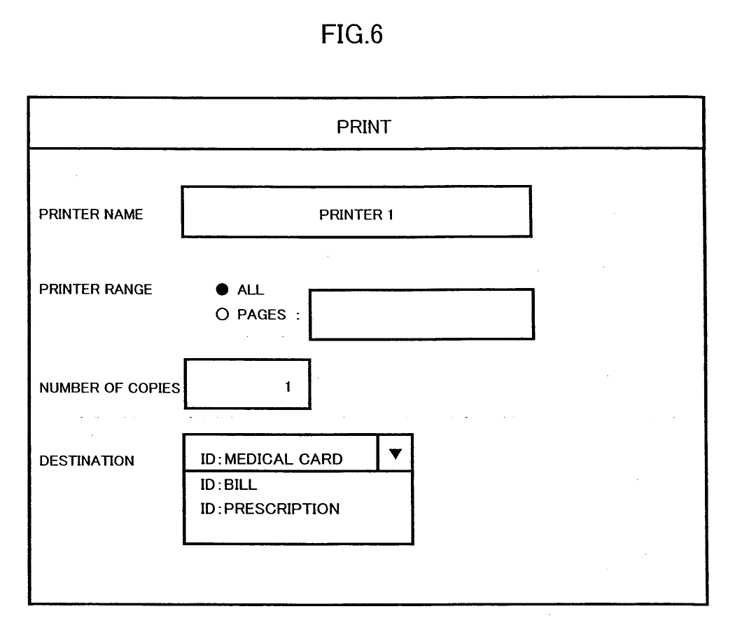

FIG. 6 is an output instruction screen (to specify an output business ID). The output instruction screen shown in FIG. 6 is the same as the output instruction screen shown in FIG. 5, except that the destination to which the print report is to be sent is specified based on a business type.

FIG. 7 includes two types of print completion report screens, one for a case where an output terminal ID is specified and the other for a case where a business ID is specified.

The processing flow of the print server 1 will be described with reference to the drawings. A user starts an application program on the terminal 31 (ID=1) to execute a printing operation by making appropriate instructions on the output instruction screen shown in FIG. 6. In the output instruction screen, “ID: prescription” is entered in the “destination” field. Then, a printer driver installed in the terminal 31 generates print data in a form compatible with the specification of the printer 2 to send the print data in combination with the print requesting terminal ID and the print-completion-report destination business ID to the print server 1 to make a print request.

When the print server 1 receives the print request, the print data receiving unit 14 stores the print data in a storage area (not shown), and allocates a print request number in the print request database 11, so that the requesting terminal ID, the print-completion-report destination business, and the data pointer are stored in the manner shown in, for example, No. 0001 of FIG. 3. The print data transmitting unit 15 of the print server 1 constantly monitors an input buffer of the printer 2, and sends the print data in turn to the printer 2 when the input buffer becomes empty. When the printer 2 receives the print data from the print server 1, it stores the print data in a storage area and prints the data.

The printer 2 transmits print status, such as print completion information or print error information, and the print request number to the print server 1.

When the print server 1 receives the print status from the printer 2, the print status receiving unit 16 determines whether or not the print status indicates print completion. If the print status indicates print completion, a print-completion-report destination business is specified based on the print request number and the print request database 11 (shown in FIG. 3). In this example, the print request No. 0001 is employed, and the print-completion-report destination business is a prescription service. Then, the terminal handling this business is determined from the distribution table 12. According to the distribution table shown in FIG. 4, the terminal ID=3 handles the prescription service. The print completion report of the print request No. 0001 is thus sent to the terminal ID=3 (the terminal 33). Then, the print record managing unit 17 deletes the print request No. 0001 data from the print request database 11, and the printing operation ends.

Accordingly, the print server 1 which receives a print request from any of the terminals 31 to 33 can manage the print request information including the print-completion-report destination terminal information, and can send print data to the printer 2. When the print server 1 receives a print completion report from the printer 2, it can send the print completion report to the print-completion-report destination terminal specified by the print requesting terminal.

The terminals 31 to 33 need not recognize information for identifying a destination terminal when they specify a print-completion-report destination terminal. Once they specify a business that uses the printed document, the print server 1 can identify the terminal handling the specified business and send the print completion report to this terminal. Therefore, each terminal user need not recognize information of the print-completion-report destination terminal.

In the foregoing embodiment of the present invention, the print server 1 and the printer 2 are separate systems; however, the printer 2 itself may have a print server function. In this case, the terminals 31 to 33 can directly send print data to the printer 2, and the printer 2 identifies the destination terminal to which a print completion report is to be sent.

What is claimed is:

1. A method of reporting the status of execution of a print job by a print server, the print server receiving print data and a print request from one of terminals connected to a network and transmitting the print data to a printer and managing the print status of the printer, the method comprising the steps of:
receiving print data and a print request by a terminal, the print request including information of the terminal to which a report of the execution result of the print job is to be transmitted, and storing the print data and the print request in a print request database;
transmitting the print data to the printer; and
transmitting the report to the specified terminal according to the information stored in the database when the print server receives the report from the printer.

2. A method of reporting the status of execution of a print job by a print server, the print server receiving print data and a print request from one of terminals connected to a network, transmitting the print data to a printer and managing the print status of the printer, the method comprising the steps of:
preparing a distribution table including information to specify assigned terminals corresponding to respective businesses;
receiving from a terminal print data and a print request including information of the business corresponding to the terminal to which a report of the execution result of the print job is to be transmitted, and storing the print data and the print request in a print request database;
transmitting the print data to the printer; and
transmitting the report to the specified terminal according to the table when the print server receives the report from the printer.

3. A method of reporting the status of execution of a print job by a printer, for managing the print status of the printer, the printer receiving print data from one of terminals connected to a network, the method comprising the steps of:
receiving from the terminal print data with a print request including information of a terminal to which a report of the execution result of the print job is to be transmitted, and storing the print data and the print request in a print request database; and
transmitting the report of execution of the print job to the specified terminal according to the information stored in the database when the print job is completed.

4. A method of reporting the status of execution of a print job by a printer, for managing the print status of the printer, the printer receiving print data from one of terminals connected to a network, the method comprising the steps of:
preparing a distribution table including information to specify assigned terminals corresponding to respective businesses;
receiving from a terminal print data with a print request including information of the business corresponding to the terminal to which a report of the execution result of the print job is to be transmitted, and storing the print data and the print request in a print request database; and
transmitting the report to the specified terminal according to the information of the business corresponding to the specified terminal stored in the print request database and the table when the print job is completed.

5. A storage medium on which is stored a program for reporting the print status of a printer by a print server for managing the print status, the print server receiving a print request from a terminal connected to a network, the program comprising codes for:
a step in which the print server receives from the terminal print data and a print request including instructions of the terminal to which a report of the execution result of the print job is to be sent, and in which the print server stores the print data and the print request in a print request database;
a step in which said print server transmits the print data to the printer; and
a step in which said print server transmits the report to the specified terminal according to the information stored in the database when the report is received from the printer.

6. A storage medium on which is stored a program for reporting the print status of a printer by a print server for managing the print status, said print server receiving a print request from a terminal connected to a network, the program comprising codes for:
a step in which the print server receives from the terminal print data and a print request including information of a business corresponding to the terminal to which a report of the execution result of the print job requested is to be sent, and in which the print server stores the print data and the print request in a print request database;
a step in which the print server transmits the print data to the printer; and
a step in which the print server transmits the report to the specified terminal according to the information of the business corresponding to the terminal stored in the print request database and the table when the report is received from the printer.

7. A print server receiving print data and a print request from one of terminals connected to a network, transmitting the print data to a printer, and managing the print status of the printer,
wherein said print server comprises:
a print data receiving unit for receiving print data and information of the specified terminal to which a report of print completion is to be sent, and storing the print data with the information in a print database;
a print data transmitting unit for transmitting print data to the printer; and
a print status receiving unit for specifying the terminal to which the report is to be sent, and transmitting the report to the terminal when the print server receives the report from the printer.

8. A printer for receiving print data from one of terminals connected to a network and for managing its own print status,
wherein said printer comprises:
a unit for receiving print data and information of the specified terminal to which a report of print completion is to be sent, and storing the print data in a print request database; and
a unit for specifying the terminal to which the report is to be transmitted, and transmitting the report to the terminal when the print job is completed.
